(19) United States
(12) Patent Application Publication
(10) Pub. No.: US 2025/0150708 A1
(43) Pub. Date: May 8, 2025

(54) DATA PROCESSING DEVICE, IMAGING SYSTEM, AND DISTANCE MEASURING SYSTEM

(71) Applicant: Sony Semiconductor Solutions Corporation, Kanagawa (JP)

(72) Inventor: Kumiko Mahara, Kanagawa (JP)

(21) Appl. No.: 18/725,634

(22) PCT Filed: Feb. 10, 2022
(86) PCT No.: PCT/JP22/05394

§ 371 Date: Jan. 23, 2025

(51) Int. Cl. H04N 23/67; G01B 11/22; G01S 7/4865; G01S 17/894; H04L 9/40; H04N 23/73; H04N 23/76

(52) U.S. Cl. CPC H04N 23/672; G01B 11/22; G01S 7/4865; G01S 17/894; H04L 63/0428; H04N 23/73; H04N 23/76

(57) ABSTRACT

The present disclosure relates to a data processing device, an imaging system, and a distance measuring system that enable more suitable transmission of data.

A security processing unit performs security processing for each group including designated data among a plurality of types of data for one frame obtained from a sensor chip, and a transmission unit frames data acquired by the security processing by the security processing unit and transmits the data to a host device. Then, the group is set according to a unit of data read from a memory that temporarily stores the data transmitted from the transmission unit in a host device. The present technology can be applied to, for example, an imaging system and a distance measuring system.

### TECHNICAL FIELD

The present disclosure relates to a data processing device, an imaging system, and a distance measuring system, and more particularly, to a data processing device, an imaging system, and a distance measuring system that enable more suitable transmission of data.

### BACKGROUND ART

Conventionally, data transmission standards capable of transmitting different types of data such as image data and image plane phase difference data from an imaging element to a host device has been proposed. For example, in a data transmission standard in which a plurality of types of data is transmitted in one frame from a frame start to a frame end, each type of data is distinguished by identification (ID).

For example, Patent Document 1 discloses a technique of distinguishing a configuration element having acquired data by a configuration element ID associated with an imaging configuration element in a method of performing communication between imaging configuration elements of an X-ray imaging system.

### CITATION LIST

### Patent Document

Patent Document 1: Japanese Translation of PCT International Application Publication No. 2020-533924

### SUMMARY OF THE INVENTION

### Problems to be Solved by the Invention

By the way, in a case where the entirety of data from the frame start to the frame end is set as one processing range in which security processing is performed, there is a concern that it becomes difficult to handle the data in subsequent processing serving as a data transmission destination. Therefore, there is a demand for a more suitable data transmission method including handling of data in the subsequent processing.

The present disclosure has been made in view of such a situation, and is intended to enable more suitable transmission of data.

### Solutions to Problems

A data processing device according to the first aspect of the present disclosure includes: a security processing unit configured to perform security processing for each group including designated data among a plurality of types of data for one frame obtained from a sensor chip; and a transmission unit configured to frame data acquired by the security processing by the security processing unit and transmit the data to a host device.

In the first aspect of the present disclosure, security processing is performed for each group including designated data among a plurality of types of data for one frame obtained from a sensor chip, and data acquired by the security processing is framed and transmitted to a host device.

An imaging system according to the second aspect of the present disclosure includes: an image sensor chip capable of acquiring image data or image plane phase difference data; a security processing unit configured to perform security processing for each group including designated data among a plurality of types of data for one frame obtained from the image sensor chip; and a transmission unit configured to frame data acquired by the security processing by the security processing unit and transmit the data to a host device, in which the security processing unit performs the security processing for each of the group including the image data and the group including the image plane phase difference data.

In the second aspect of the present disclosure, security processing is performed for each group including designated data among a plurality of types of data for one frame obtained from an image sensor chip capable of acquiring image data or image plane phase difference data, and data acquired by the security processing is framed and transmitted to a host device. Then, the security processing is performed for each of the group including the image data and the group including the image plane phase difference data.

A distance measuring system according to the third aspect of the present disclosure includes: an iTOF sensor chip used to measure a distance to an object from a phase shift in reflected light of pulsed light output toward the object; a security processing unit configured to perform security processing for each group including designated data among a plurality of types of data for one frame obtained from the iTOF sensor chip; and a transmission unit configured to frame data acquired by the security processing by the security processing unit and transmit the data to a host device, in which the security processing unit performs the security processing for each of the group including luminance data having a different phase output from the iTOF sensor chip.

In the third aspect of the present disclosure, security processing is performed for each group including designated data among a plurality of types of data for one frame obtained from an iTOF sensor chip used to measure a distance to an object from a phase shift in reflected light of pulsed light output toward the object, and data acquired by the security processing is framed and transmitted to a host device. Then, the security processing is performed for each of the group including luminance data having a different phase output from the iTOF sensor chip.

### BRIEF DESCRIPTION OF DRAWINGS

FIG. 1 is a block diagram illustrating a configuration example of an imaging system that is a first embodiment to which the present technology is applied.

FIG. 2 is diagrams illustrating configuration examples of frame structures in which designated data in one frame is set as a security group.

FIG. 3 is a diagram illustrating a configuration example of a frame structure in which entire data of one frame is set as a security group.

FIG. 4 is diagrams for describing an identification method in SLVS-EC.

FIG. 5 is diagrams for describing an identification method in MIPI.

FIG. 6 is a block diagram illustrating a configuration example of a distance measuring system that is a second embodiment to which the present technology is applied.

FIG. 7 is a diagram illustrating a configuration example of a frame structure in which designated data in one frame is set as a security group.

FIG. 8 is a diagram illustrating a configuration example of a frame structure in which entire data of one frame is set as a security group.

FIG. 9 is a diagram illustrating a configuration example of a frame structure applied to a dual-gain method.

FIG. 10 is a diagram illustrating a first modification of the configuration example of a frame structure applied to a dual-gain method.

FIG. 11 is a diagram illustrating a second modification of the configuration example of a frame structure applied to a dual-gain method.

FIG. 12 is a diagram illustrating a configuration example of a frame structure applied to a digital overlap method.

FIG. 13 is a block diagram illustrating a configuration example of an imaging device.

FIG. 14 is a diagram illustrating use examples of using an image sensor.

### MODE FOR CARRYING OUT THE INVENTION

Hereinafter, specific embodiments to which the present technology is applied will be described in detail with reference to the drawings.

### <Configuration Example of Imaging System>

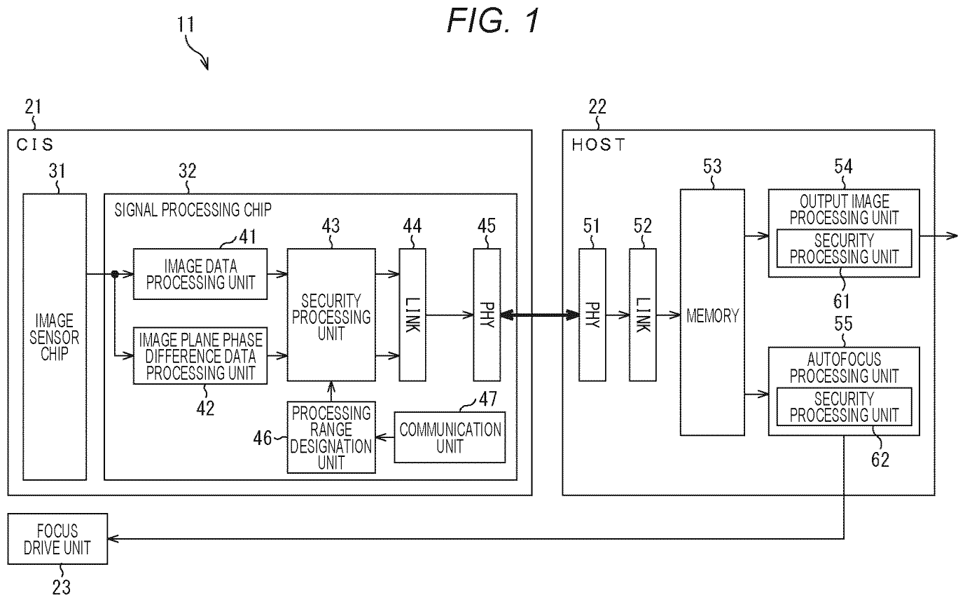

FIG. 1 is a block diagram illustrating a configuration example of an imaging system that is a first embodiment to which the present technology is applied.

An imaging system 11 illustrated in FIG. 1 is configured by connecting an imaging element 21 including a complementary metal oxide semiconductor (CMOS) image sensor (CIS) and a host device 22 including a field programmable gate array (FPGA), a digital signal processor (DSP), or the like via a predetermined communication interface. Furthermore, the imaging system 11 is provided with a focus drive unit 23 for driving a focus lens of an optical system that forms an image of an object on an imaging surface of the imaging element 21.

For example, it is assumed that a data transmission standard such as scalable low voltage signaling with embedded clock (SLVS-EC), mobile industry processor interface alliance (MIPI), or sub low voltage differential signaling (LVDS) is adopted as a communication interface used in the imaging system 11. Of course, the present invention is not limited to these data transmission standards, and various other data transmission standards may be adopted.

The imaging element 21 has a laminated structure in which an image sensor chip 31 and a signal processing chip 32 are laminated.

The image sensor chip 31 has a plurality of pixels arranged on the imaging surface, and outputs a pixel signal corresponding to an amount of light received by each pixel. For example, on the imaging surface of the image sensor chip 31, an R pixel that receives light transmitted through a red filter, a G pixel that receives light transmitted through a green filter, and a B pixel that receives light transmitted through a blue filter are arranged in a Bayer array. Moreover, on the imaging surface of the image sensor chip 31, image plane phase difference pixels for detecting a phase difference on the imaging surface are arranged instead of some G pixels. Therefore, image data and image plane phase difference data can be acquired from the pixel signal output from the image sensor chip 31.

The signal processing chip 32 includes an image data processing unit 41, an image plane phase difference data processing unit 42, a security processing unit 43, a link layer interface 44, a physical layer interface 45, a processing range designation unit 46, and a communication unit 47. For example, the pixel signals output from the R pixel, the G pixel, and the B pixel of the image sensor chip 31 are supplied to the image data processing unit 41, and the pixel signals output from the image plane phase difference pixels of the image sensor chip 31 are supplied to the image plane phase difference data processing unit 42.

The image data processing unit 41 performs image data processing for generating RAW data from the pixel signals output from the R pixel, the G pixel, and the B pixel, and supplies the RAW data generated by the image data processing to the security processing unit 43. For example, the image data processing unit 41 can generate image data obtained by removing information of the image plane phase difference pixels or image data obtained by interpolating information of the image plane phase difference pixels as the RAW data. Furthermore, in a monitoring mode or the like, the image data processing unit 41 can generate addition data obtained by adding the pixel signals of a plurality of pixels of a same color as the RAW data after separating the information of image plane phase difference pixels. Moreover, the image data processing unit 41 generates embedded data including additional information (for example, values of a gain, white balance, and an exposure time) other than images, and supplies the embedded data to the security processing unit 43.

The image plane phase difference data processing unit 42 performs image plane phase difference data processing for generating the image plane phase difference data indicating a distance to the object from the pixel signal output from the image plane phase difference pixel, and supplies the image plane phase difference data generated by the image plane phase difference data processing to the security processing unit 43.

The security processing unit 43 performs security processing necessary for ensuring security for the embedded data and the RAW data supplied from the image data processing unit 41 and the image plane phase difference data supplied from the image plane phase difference data processing unit 42 for each data in a predetermined processing range. For example, among the embedded data, the RAW data, and the image plane phase difference data for one frame, the security processing unit 43 can set data in a processing range according to specifications, register settings, and the like as a security group in advance and perform the security processing for each of the security group. For example, data serving as the security group is designated according to the number of lines, the type of data, and the unit of data read from a memory 53 of the host device 22.

Here, in the security processing, any one of processing of encrypting or decrypting the data of the security group or processing of adding security information such as a cyclic redundancy check (CRC) or a message authentication code (MAC) obtained from the data of the security group to guarantee integrity or functional safety of the data is performed. Alternatively, in the security processing, these pieces of processing may be performed in combination. Note that the CRC added in the security processing is a CRC that can be retained even after high-speed interface communication, which is different from a CRC and an error correction code (ECC) for a communication path.

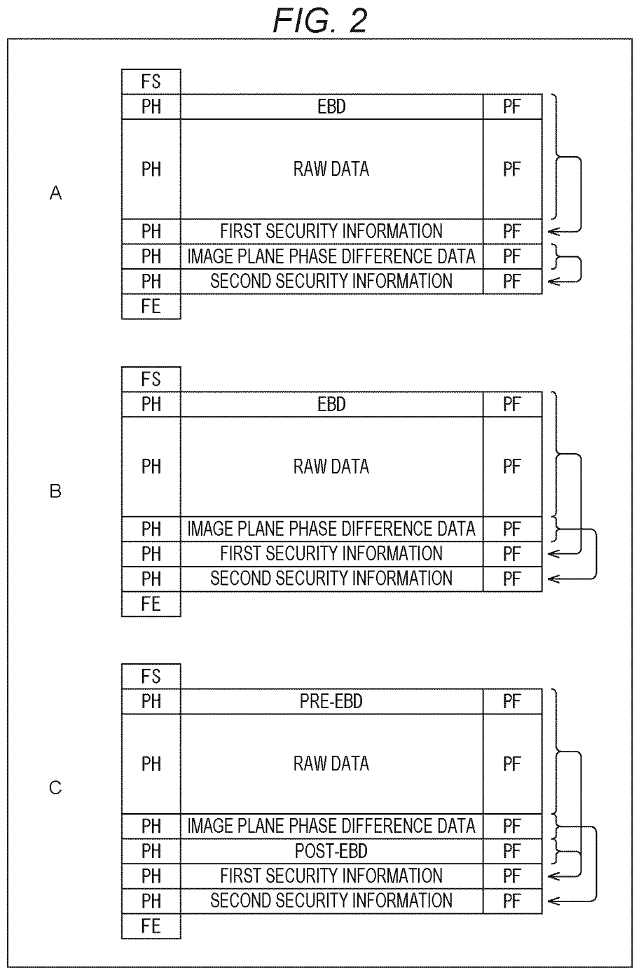

For example, as illustrated in A of FIG. 2 to be described below, the security processing unit 43 can perform security processing of encrypting the embedded data and the RAW data as a security group and adding first security information obtained from the embedded data and the RAW data. Moreover, the security processing unit 43 can perform security processing of encrypting the image plane phase difference data as a security group and adding second security information obtained from the image plane phase difference data.

The link layer interface 44 performs processing related to a link layer in communication with the host device 22 according to the standard of the communication interface (for example, SLVS-EC or MIPI) used in the imaging system 11, and transmits data. For example, the link layer interface 44 performs processing of storing, in a payload for each data of one packet, data for which the security processing has been performed for each security group in the security processing unit 43, and adding a packet header PH and a packet footer PF to packetize the data. Furthermore, the link layer interface 44 performs processing of adding a frame start FS, which is a signal indicating the start of a frame, and a frame end FE, which is a signal indicating the end of a frame, to the data of one frame for which the security processing has been performed for each security group in the security processing unit 43, to frame the data.

The physical layer interface 45 performs processing related to a physical layer in communication with the host device 22 according to any one of A-PHY, C-PHY, or D-PHY compliant with the MIPI standard, and transmits data. Note that the physical layer interface 45 may adopt another standard such as SLVS or subLVDS.

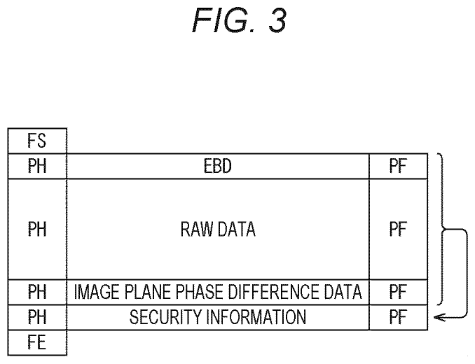

The processing range designation unit 46 designates data for each security group to be a processing range when the security processing unit 43 performs the security processing according to processing range setting information supplied from the outside via the communication unit 47. Note that data designated as the security group by the processing range designation unit 46 will be described below with reference to FIGS. 2 and 3.

The communication unit 47 performs communication necessary for performing control for the imaging element 21 from the outside. For example, when acquiring the processing range setting information by communication with the outside, the communication unit 47 supplies the processing range setting information to the processing range designation unit 46.

The host device 22 includes a physical layer interface 51, a link layer interface 52, the memory 53, an output image processing unit 54, and an autofocus processing unit 55. Furthermore, the output image processing unit 54 includes a security processing unit 61, and the autofocus processing unit 55 includes a security processing unit 62.

The physical layer interface 51 performs, similarly to the physical layer interface 45, processing related to a physical layer in communication with the imaging element 21 according to any one of A-PHY, C-PHY, or D-PHY compliant with the MIPI standard.

The link layer interface 52 performs, similarly to the link layer interface 44, processing related to a link layer in communication with the imaging element 21 according to the standard of the communication interface used in the imaging system 11.

The memory 53 temporarily stores the embedded data, the RAW data, the image plane phase difference data, and the security information transmitted from the imaging element 21.

The output image processing unit 54 performs output image processing of reading the embedded data and the RAW data from the memory 53, and generating an output image to be output to a display unit in a subsequent stage (not illustrated). At this time, in the output image processing unit 54, for example, as illustrated in A of FIG. 2 to be described below, in the case where the embedded data and the RAW data are encrypted as a security group and the first security information required from the security group is added, the security processing unit 61 can perform processing of decrypting the embedded data and the RAW data as the security group and perform processing related to integrity confirmation and functional safety of data by using the first security information.

The autofocus processing unit 55 performs autofocus processing of reading the image plane phase difference data from the memory 53, and controlling the focus drive unit 23 according to the distance to the object based on the image plane phase difference data. At this time, in the output image processing unit 54, for example, as illustrated in A of FIG. 2 to be described below, in the case where the image plane phase difference data is encrypted as a security group and the second security information required from the security group is added, the security processing unit 62 can perform processing of decrypting the image plane phase difference data as the security group and perform processing related to integrity confirmation and functional safety of data by using the second security information.

The imaging system 11 is configured as described above, and data for which the security processing has been performed for each security group in the security processing unit 43 is transmitted from the imaging element 21 to the host device 22. Therefore, in the host device 22, the output image processing unit 54 can collectively read the embedded data and the RAW data for which the security processing has been performed as one security group from the memory 53, and the autofocus processing unit 55 can read the image plane phase difference data for which the security processing has been performed as one security group from the memory 53.

That is, the imaging system 11 can easily handle data in the host device 22 by setting the security group according to the unit of data read from the memory 53. For example, in the host device 22, since paths to the RAW data and to the image plane phase difference data are different, the data can be easily handled in the output image processing unit 54 and the autofocus processing unit 55 by encrypting each piece of data or generating the security information such as CRC or MAC for each piece of the data.

Furthermore, for example, even in a case where the security processing is performed for each line of data, it is conceivable that the output image processing unit 54 and the autofocus processing unit 55 can read only necessary data in the host device 22. However, in this case, disadvantages are assumed such as an increase in the frequency of requiring band-limiting key exchange and necessity of an additional function for line missing in a frame.

In contrast, the imaging system 11 can more suitably transmit the data by performing the security processing for each group including the designated data among the plurality of types of data.

FIG. 2 is diagrams illustrating frame structures when data is transmitted from the imaging element 21 to the host device 22 in the imaging system 11.

In a first frame structure illustrated in A of FIG. 2, the data is arranged in the order of the embedded data, the RAW data, the first security information, the image plane phase difference data, and the second security data from the frame start to the frame end to form one frame. That is, in the first frame structure, the processing range is designated to set the embedded data and the RAW data as the security group, and the processing range is designated to set the image plane phase difference data as the security group. Then, in the security processing, the first security information is obtained from the embedded data and the RAW data and arranged next to the RAW data, and the second security information is obtained from the image plane phase difference data and arranged next to the image plane phase difference data.

In a second frame structure illustrated in B of FIG. 2, the data is arranged in the order of the embedded data, the RAW data, the image plane phase difference data, the first security information, and the second security data from the frame start to the frame end to form one frame. That is, in the second frame structure, the processing range is designated to set the embedded data and the RAW data as the security group, and the processing range is designated to set the image plane phase difference data as the security group. Then, in the security processing, the first security information is obtained from the embedded data and the RAW data and arranged next to the image plane phase difference data, and the second security information is obtained from the image plane phase difference data and arranged next to the first security information.

In a third frame structure illustrated in C of FIG. 2, the data is arranged in the order of pre-embedded data, the RAW data, the image plane phase difference data, post-embedded data, the first security information, and the second security data from the frame start to the frame end to form one frame. That is, in the third frame structure, the processing range is designated to set the pre-embedded data, the RAW data, and the post-embedded data as the security group, and the processing range is designated to set the image plane phase difference data as the security group. Then, in the security processing, the first security information is obtained from the pre-embedded data, the RAW data, and the post-embedded data and arranged next to the post-embedded data, and the second security information is obtained from the image plane phase difference data and arranged next to the first security information.

As described above, in the imaging system 11, the processing range to be set as the security group is set. Moreover, in the imaging system 11, the processing range to be set as the security group can be switched.

For example, as illustrated in FIG. 3, the imaging system 11 can designate all of the embedded data, the RAW data, and the image plane phase difference data of one frame as a security group, and can add the security information obtained from the security group. Then, in the imaging system 11, the processing range designation unit 46 can switch setting designated data in one frame as the security group as illustrated in FIG. 2 and setting the entire data of one frame as the security group as illustrated in FIG. 3.

Note that, in the examples illustrated in FIG. 2, the embedded data and the RAW data are collectively designated as the security group, but the embedded data and the RAW data may be individually designated as the security groups, and the security processing may be performed of each of them.

Moreover, also in a case where metadata (for example, information for motion detection, feature points, object position information, automatic exposure, automatic white balance, and the like) can be extracted from the RAW data in the signal processing chip 32, an as-needed security group can be similarly set for the metadata.

Furthermore, the security information may be output immediately after each piece of target data in accordance with band processing, or may be collectively output in a V blank period after transmission of target data.

### <Security Group Identification Method>

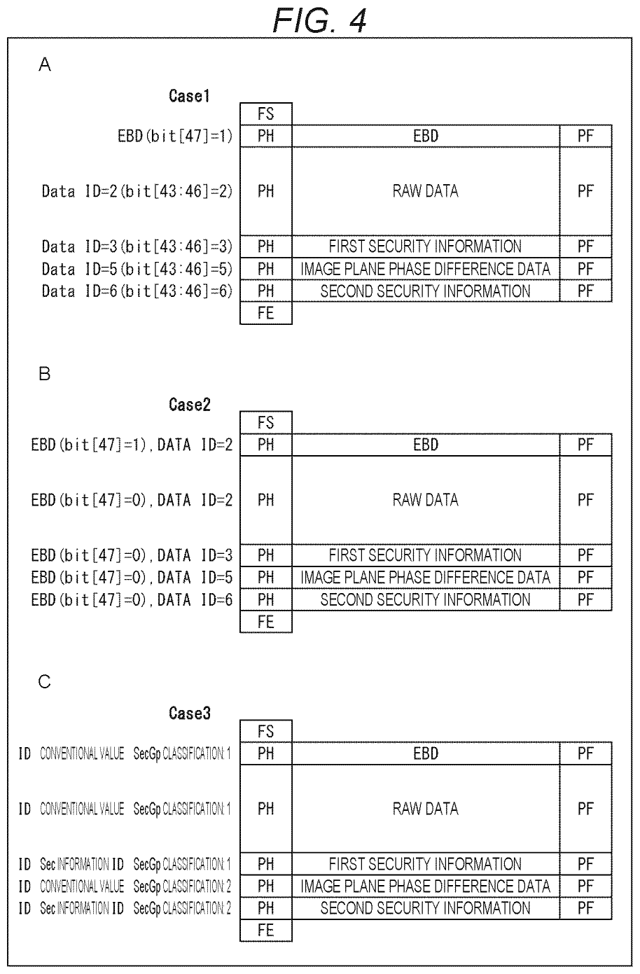

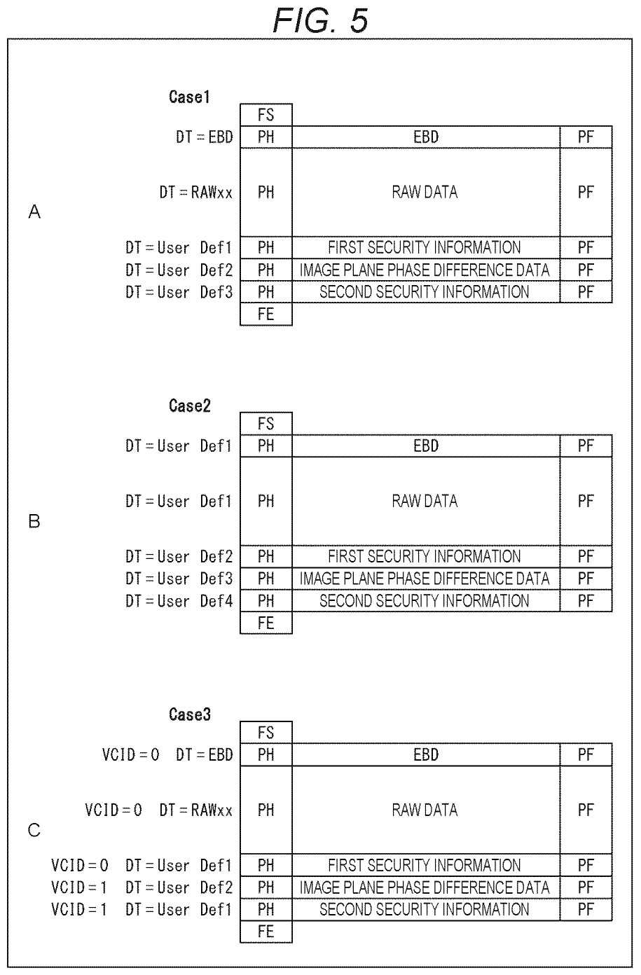

An identification method for identifying a security group in the imaging system 11 will be described with reference to FIGS. 4 and 5.

For example, in the imaging system 11, the security group can be identified by an ID of data added for each line of data to be transmitted or the like. For example, a data ID of the packet header can be used in the SLVS-EC, and a data type of the packet header can be used in the MIPI. Furthermore, in a case where the ID of data is not standardized like the SLVS (subLVDS), there is a case where data (Line Info) indicating line information is used at the head of line data or the like, and the data can be used.

FIG. 4 is diagrams illustrating a method of identifying the security group in the case where the SLVS-EC is adopted as the communication interface used in the imaging system 11.

In the first case illustrated in A of FIG. 4, a specification is set such that the embedded data and data (the RAW data in the illustrated example) having the data ID of 2 are set as the security group. Furthermore, in the illustrated example, the specification is set such that the first security information obtained from the embedded data and the RAW data is output with the data ID of 3.

In the second case illustrated in B of FIG. 4, the specification is set such that pieces of data having the same data ID are set as the security group. In the illustrated example, the specification is set such that the embedded data and the RAW data that are data having the data ID of 2 are set as the security group, and the first security information obtained from the embedded data and the RAW data is output with the data ID of 3.

As described above, in the first case and the second case, the host device 22 on the reception side can recognize the data set as the security group by confirming whether or not the data is the embedded data and confirming the data ID.

In the third case illustrated in C of FIG. 4, as in a conventional case, the specification is set so as to notify that a MAC is to be generated and the security group in a reserved area. For example, a bit of the reserved area is used to recognize that a MAC is to be generated. Furthermore, in a case where a new row is output as the information indicating the security group, an ID number can be newly allocated for outputting the information. In this case, a conventional ID region may be used or the reserved region may be used.

As described above, in the SLVS-EC, the security group can be designated using the embedded data, the data ID, and the reserved area. Note that which data is set as the security group may be determined depending on a product on which the imaging system 11 is mounted, or may be set by a register or the like.

FIG. 5 is diagrams illustrating a method of identifying the security group in the case where the MIPI is adopted as the communication interface used in the imaging system 11.

In the first case illustrated in A of FIG. 5, the specification is set such that the embedded data having the data type of EBD and data (the RAW data in the illustrated example) having the data type of RAWxx are set as the security group. Furthermore, in the illustrated example, the specification is set such that the first security information obtained from the embedded data and the RAW data is output with the data type of User Def1.

In the second case illustrated in B of FIG. 5, the specification is set such that pieces of data having the same data type are set as the security group. In the illustrated example, the specification is set such that the embedded data and the RAW data having the data type of User Def1 are set as the security group, and the first security information obtained from the embedded data and the RAW data is output with the data type of User Def2.

In the third case illustrated in C of FIG. 5, the specification is set so as to notify that a MAC is to be generated and the security group with a virtual channel ID. Furthermore, in the third case, since the security group is identified by the virtual channel ID, the line for outputting the security information can be unified by a value of the data type (User Def1 in the illustrated example).

Note that the identification methods described with reference to FIGS. 4 and 5 are examples, and other identification methods, for example, the identification information may be embedded in the payload data instead of the packet header, and the security group for which the security processing is performed may be identified.

### <Configuration Example of Distance Measuring System>

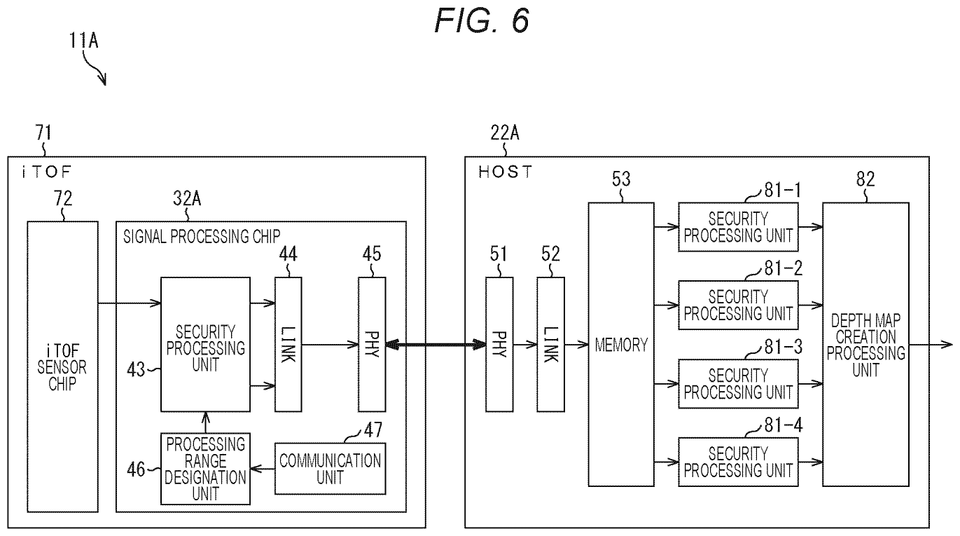

FIG. 6 is a block diagram illustrating a configuration example of a distance measuring system that is a second embodiment to which the present technology is applied. Note that, in a distance measuring system 11A illustrated in FIG. 6, configurations common to those of the imaging system 11 in FIG. 1 are denoted by the same reference numerals, and detailed description thereof will be omitted.

In the distance measuring system 11A, an iTOF device 71 and a host device 22A are connected via a communication interface that adopts a data transmission standard such as SLVS-EC, MIPI, or subLVDS, similarly to the imaging system 11.

The iTOF device 71 has a laminated structure in which an iTOF sensor chip 72 and a signal processing chip 32A are laminated.

The iTOF sensor chip 72 outputs, for example, pulsed light having different phases from 0°, 90°, 180°, and 270° on the basis of an indirect time of flight (iTOF) method for measuring a distance to an object from a phase shift in reflected light of pulsed light output toward the object, and acquires an amount of reflected light of each pulsed light reflected by the object. Then, the iTOF sensor chip 72 outputs, for each pixel, luminance data indicating each of four amounts of light acquired for each of the phases.

The signal processing chip 32A is similarly configured to the signal processing chip 32 in FIG. 1 in including a security processing unit 43, a link layer interface 44, a physical layer interface 45, a processing range designation unit 46, and a communication unit 47.

That is, in the signal processing chip 32A, the luminance data for each of the four phases (0°, 90°, 180°, and 270°) output from the iTOF sensor chip 72 is supplied to the security processing unit 43, and security processing is performed for the luminance data. For example, in a case where the processing range designation unit 46 designates a processing range so as to set each of the pieces of luminance data having different phases as a security group, the security processing unit 43 performs the security processing for the luminance data for each phase.

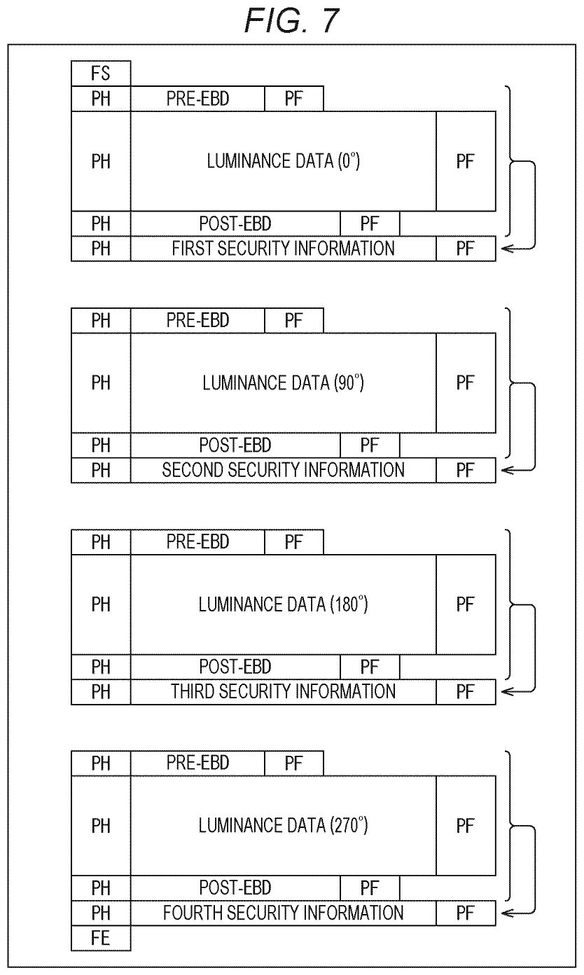

Therefore, in this case, as illustrated in FIG. 7, encryption is performed setting pre-embedded data, the luminance data of the phase of 0°, and post-embedded data as a security group, and first security information obtained from the security group is arranged next to the post-embedded data. Similarly, the encryption is performed setting the pre-embedded data, the luminance data of the phase of 90°, and the post-embedded data as a security group, and second security information obtained from the security group is arranged next to the post-embedded data.

Furthermore, the encryption is performed setting the pre-embedded data, the luminance data of the phase of 180°, and the post-embedded data as a security group, and third security information obtained from the security group is arranged next to the post-embedded data. Finally, the encryption is performed setting the pre-embedded data, the luminance data of the phase of 270°, and the post-embedded data as a security group, and fourth security information obtained from the security group is arranged next to the post-embedded data.

Then, data obtained by performing the security processing for each security group in the security processing unit 43 is transmitted to the host device 22A via the link layer interface 44 and the physical layer interface 45.

The host device 22A is configured similarly to the host device 22 in FIG. 1 in including a physical layer interface 51, a link layer interface 52, and a memory 53. Then, in the host device 22A, the data transmitted from the iTOF device 71 is temporarily stored in the memory 53 via the physical layer interface 51 and the link layer interface 52.

Moreover, the host device 22A includes security processing units 81-1 to 81-4 and a depth map creation processing unit 82.

The security processing units 81-1 to 81-4 read the luminance data for each phase stored in the memory 53, perform processing of decrypting the luminance data for each security group, and perform processing related to functional safety using the corresponding security information. Then, each of the security processing units 81-1 to 81-4 supplies the luminance data to the depth map creation processing unit 82 for each line.

For example, the security processing unit 81-1 reads the pre-embedded data, the luminance data of the phase of 0°, and the post-embedded data from the memory 53, performs the processing of decrypting them as a security group, and performs the processing related to functional safety using the first security information. Furthermore, the security processing unit 81-2 reads the pre-embedded data, the luminance data of the phase of 90°, and the post-embedded data from the memory 53, performs the processing of decrypting them as a security group, and performs the processing related to functional safety using the second security information.

Similarly, the security processing unit 81-3 reads the pre-embedded data, the luminance data of the phase of 180°, and the post-embedded data from the memory 53, performs the processing of decrypting them as a security group, and performs the processing related to functional safety using the third security information. Moreover, the security processing unit 81-4 reads the pre-embedded data, the luminance data of the phase of 270°, and the post-embedded data from the memory 53, performs the processing of decrypting them as a security group, and performs the processing related to functional safety using the fourth security information.

The depth map creation processing unit 82 performs depth map creation processing of sequentially creating a depth map on which the distance to the object is mapped for each line by using the luminance data of the phase of 0° supplied from the security processing unit 81-1, the luminance data of the phase of 90° supplied from the security processing unit 81-2, the luminance data of the phase of 180° supplied from the security processing unit 81-3, and the luminance data of the phase of 270° supplied from the security processing unit 81-4. For example, the depth map creation processing unit 82 creates the first line of the depth map using the same line, that is, the first line of the luminance data of the phase of 0°, the first line of the luminance data of the phase of 90°, the first line of the luminance data of the phase of 180°, and the first line of the luminance data of the phase of 270°. Then, the depth map creation processing unit 82 outputs the depth map created by the depth map creation processing to a processing block in a subsequent stage (not illustrated).

The distance measuring system 11A is configured as described above, and the data for which the security processing has been performed for each security group in the security processing unit 43 is transmitted from the iTOF device 71 to the host device 22A. Therefore, in the host device 22A, each of the security processing units 81-1 to 81-4 can read the luminance data of each phase for which the security processing has been performed as each security group from the memory 53, and can supply the luminance data of the same line to the depth map creation processing unit 82. Therefore, in the distance measuring system 11A, the data can be easily handled in the host device 22A.

For example, in a case where the security processing is collectively performed for the four pieces of luminance data for the respective four phases, the luminance data is read from the head line of the pieces of luminance data, and it is difficult to read the same line of each luminance data. In contrast, the distance measuring system 11A can more suitably transmit data so as to easily read the same line of each luminance data.

That is, the distance measuring system 11A is configured such that the iTOF device 71 can output the luminance data in order from the head of one frame, and the host device 22A can read the luminance data from the memory 53 in the order necessary for the depth map creation processing unit 82 to create the depth map.

Furthermore, for example, in a case where data is output at a high speed as in the iTOF device 71, a plurality of pieces of data is sometimes collectively framed in consideration of the fact that the host device 22A cannot receive a frame that is too high in speed, desirably handles the data as a set of data, and the like. In this case, the iTOF device 71 can collectively output the pieces of luminance data of the four phases as one frame, and for example, the security processing unit 43 as a higher layer can execute the security processing without being conscious of positions to which a frame start and a frame end are added by the link layer interface 44.

Moreover, the distance measuring system 11A can switch the processing range to be set as the security group, similarly to the imaging system 11.

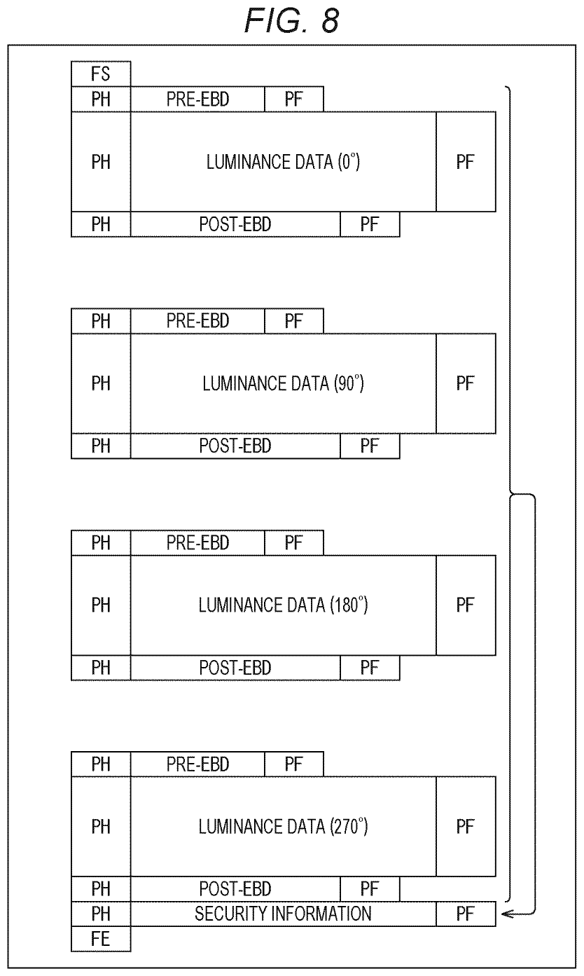

For example, the distance measuring system 11A can switch designating the luminance data for each phase in one frame as a security group as illustrated in FIG. 7 and designating all the pieces of luminance data of one frame as a security group as illustrated in FIG. 8. In the frame structure illustrated in FIG. 8, the data from the pre-embedded data of the luminance data of the phase of 0° to the post-embedded data of the luminance data of the phase of 270° are set as the security group, and the security information obtained from the security group is arranged next to the post-embedded data of the luminance data of the phase of 270°.

### <Frame Structures of Dual-Gain Method and Digital Overlap Method>

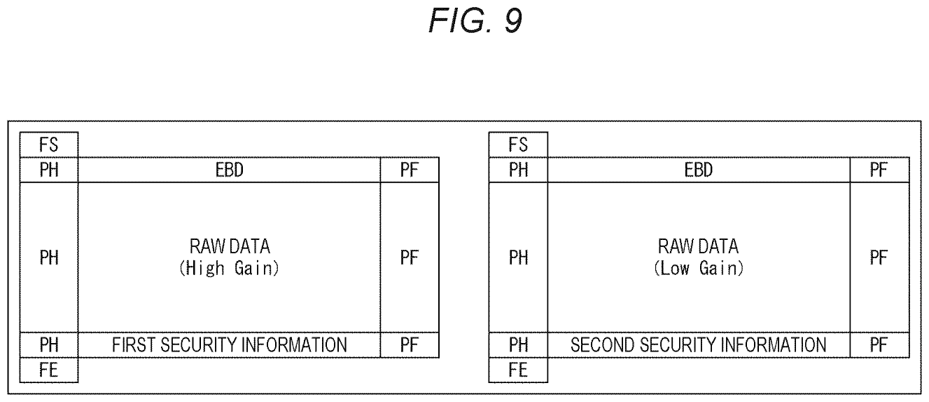

Frame structures of a dual-gain method and a digital overlap method will be described with reference to FIGS. 9 to 12.

FIG. 9 is a diagram for describing a frame structure in which the present technology is applied to a dual-gain method.

As illustrated, in the dual-gain method, different types of data such as high-gain RAW data and low-gain RAW data are output in one line. Then, the embedded data and the high-gain RAW data are set as a security group, and the first security information obtained from the security group is arranged next to the high-gain RAW data. Moreover, the embedded data and the low-gain RAW data are set as a security group, and the first security information obtained from the security group is arranged next to the low-gain RAW data. That is, the security processing is performed for each of the high-gain RAW data and the low-gain RAW data.

Furthermore, in the frame structure illustrated in FIG. 9, the frame start and the frame end are arranged in each of the high-gain RAW data and the low-gain RAW data.

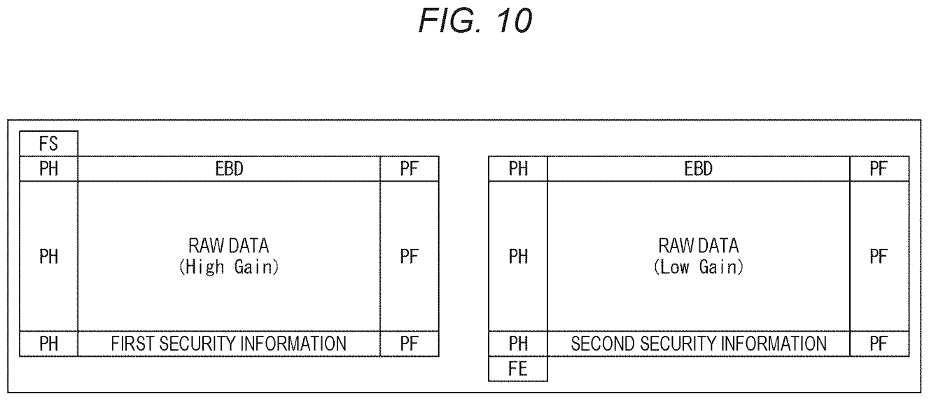

In contrast, as illustrated in FIG. 10, the frame start of the low-gain RAW data and the frame end of the high-gain RAW data may be omitted.

As described above, in the case where the present technology is applied to the dual-gain method, each of the high-gain RAW data and the low-gain RAW data can be set as the security group. Then, similarly to the description with reference to FIGS. 4 and 5, the high-gain RAW data and the low-gain RAW data can be identified by using the information included in the packet header such as the data ID, the data type, and the virtual channel ID. Then, it is possible to determine the handling of data in the host device 22, for example, to select data for which the security processing is executed, on the basis of such information included in the packet header. Furthermore, similarly to the third case described with reference to FIGS. 4 and 5, the security information can be output in a way of adding the same data ID and a security-related information flag.

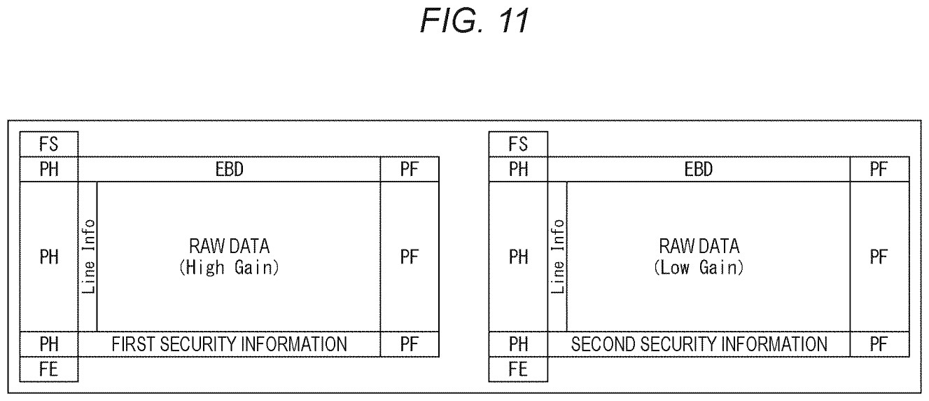

Note that line information (Line Info) may be added to the payload data as illustrated in FIG. 11 instead of using the information included in the packet header. In this case, similarly to the first case and the second case described with reference to FIGS. 4 and 5, it is necessary to set in advance the specification for identifying the security group to be the processing range in which the security processing is performed.

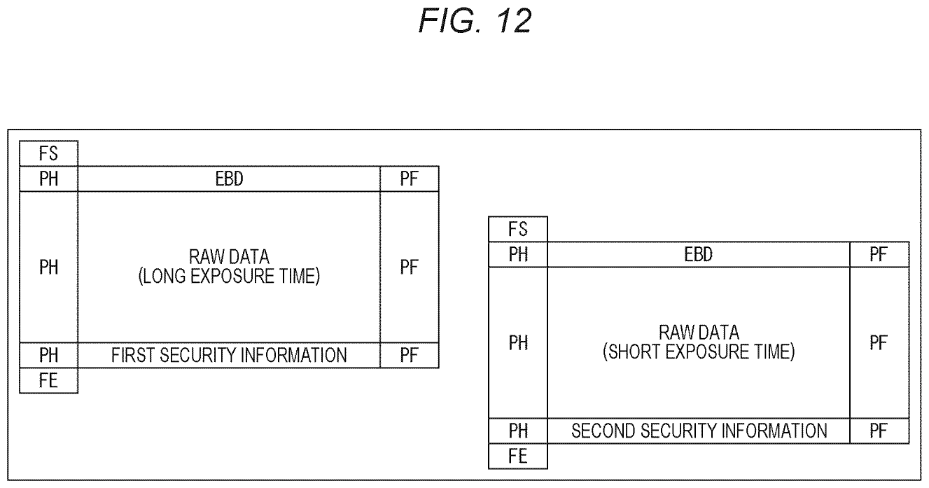

FIG. 12 is a diagram illustrating a frame structure in which the present technology is applied to a digital overlap method.

As illustrated, in the digital overlap method, different types of data such as RAW data of a long exposure time and RAW data of a short exposure time are output in one line. Note that, in the digital overlap method, timing at which the output of the RAW data of the short exposure time is started is later than timing at which the output of the RAW data of the long exposure time is started.

Then, the embedded data and the RAW data of the long exposure time are set as a security group, and the first security information obtained from the security group is arranged next to the RAW data of the long exposure time. Moreover, the embedded data and the RAW data of the short exposure time are set as a security group, and the first security information obtained from the security group is arranged next to the RAW data of the short exposure time. That is, the security processing is performed for each of the RAW data of the long exposure time and the RAW data of the short exposure time.

Even in such a digital overlap method, the security group can be identified similarly to the above-described dual-gain method.

### <Configuration Example of Electronic Device>

The above-described imaging element 21 and iTOF device 71 can be applied to various electronic devices such as an imaging system such as a digital still camera and a digital video camera, a mobile phone having an imaging function, or another device having an imaging function, for example.

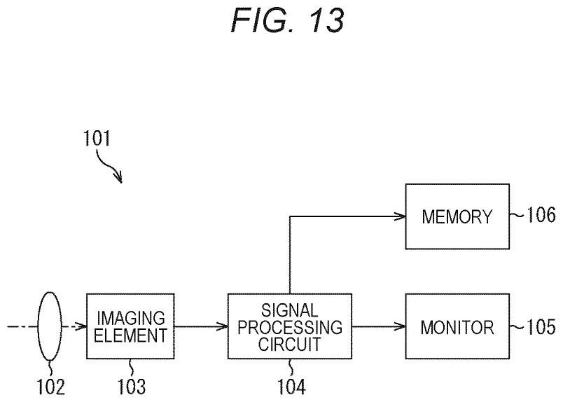

FIG. 13 is a block diagram illustrating a configuration example of an imaging device mounted on an electronic device.

As illustrated in FIG. 13, an imaging device 101 includes an optical system 102, an imaging element 103, a signal processing circuit 104, a monitor 105, and a memory 106, and can capture a still image and a moving image.

The optical system 102 includes one or a plurality of lenses, guides image light (incident light) from an object to the imaging element 103, and forms an image on a light-receiving surface (sensor unit) of the imaging element 103.

As the imaging element 103, the imaging element 21 and the iTOF device 71 described above are applied. Electrons are accumulated in the imaging element 103 for a certain period according to the image formed on the light-receiving surface via the optical system 102. Then, a signal corresponding to the electrons accumulated in the imaging element 103 is supplied to the signal processing circuit 104.

The signal processing circuit 104 performs various types of signal processing on a pixel signal output from the imaging element 103. An image (image data) obtained by the signal processing performed by the signal processing circuit 104 is supplied to the monitor 105 and displayed or supplied to the memory 106 and stored (recorded).

In the imaging device 101 configured as described above, data can be more suitably transmitted by, for example, applying the imaging element 21 and the iTOF device 71 described above.

### <Use Examples of Image Sensor>

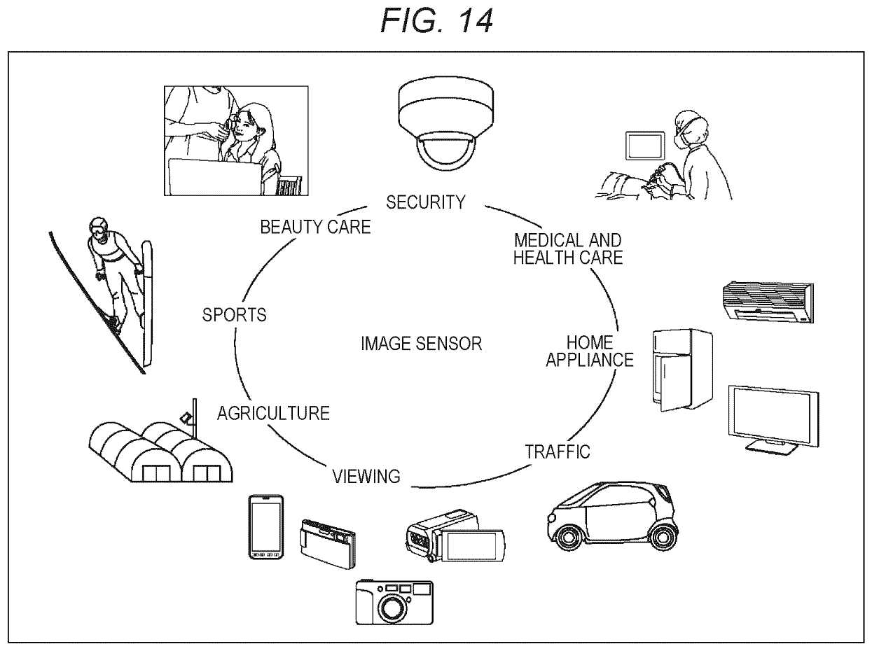

FIG. 14 is a diagram illustrating use examples of the above-described image sensor (imaging element or iTOF device).

The above-described image sensor can be used in various cases for sensing light such as visible light, infrared light, ultraviolet light, and X-ray as described below, for example.
A device that captures an image to be used for viewing, such as a digital camera and a portable device with a camera function
A device for traffic purpose such as an in-vehicle sensor which takes images of the front, rear, surroundings, interior and the like of an automobile, a surveillance camera for monitoring traveling vehicles and roads, and a distance measuring sensor which measures a distance between vehicles and the like for safe driving such as automatic stop, recognition of a driver's condition and the like
A device for home appliance such as a television, a refrigerator, and an air conditioner that images a user's gesture and performs device operation according to the gesture
A device for medical and health care use such as an endoscope and a device that performs angiography by receiving infrared light
A device for security use such as a security monitoring camera and an individual authentication camera
A device used for beauty care, such as a skin measuring instrument for imaging skin, and a microscope for imaging the scalp
A device used for sport, such as an action camera or a wearable camera for sports applications or the like
A device used for agriculture, such as a camera for monitoring a condition of a field or crop

### <Example of Combinations of Configurations>

Note that the present technology can also have the following configuration.

(1)

A data processing device including:
a security processing unit configured to perform security processing for each group including designated data among a plurality of types of data for one frame obtained from a sensor chip; and
a transmission unit configured to frame data acquired by the security processing by the security processing unit and transmit the data to a host device.
   (2)

The data processing device according to (1) described above, in which
the group is set according to a unit of data read from a memory that temporarily stores the data transmitted from the transmission unit in the host device.
   (3)

The data processing device according to (1) or (2) described above, in which
the security processing unit performs processing of obtaining security information including at least one of a cyclic redundancy check (CRC) or a message authentication code (MAC) from the data of each group and adding the security information.
   (4)

The data processing device according to any one of (1) to (3) described above, in which
the security processing unit performs processing of encrypting the data of each group.
   (5)

The data processing device according to any one of (1) to (4) described above, in which
the sensor chip is an image sensor chip capable of acquiring image data or image plane phase difference data, and
the security processing unit performs the security processing for each of the group including the image data and the group including the image plane phase difference data.
   (6)

The data processing device according to (5) described above, in which
processing of reading the image data from the memory that temporarily stores the data transmitted from the transmission unit in the host device and generating an output image is performed, and the image plane phase difference data is read and autofocus processing is performed.
   (7)

The data processing device according to any one of (1) to (4) described above, in which
the sensor chip is an iTOF sensor chip used to measure a distance to an object from a phase shift in reflected light of pulsed light output toward the object, and
the security processing unit performs the security processing for each of the group including luminance data having a different phase, the luminance data being output from the iTOF sensor chip.
   (8)

The data processing device according to (7) described above, in which
the luminance data of each phase is read line by line from the memory that temporarily stores the data transmitted from the transmission unit in the host device and a depth map is generated.
   (9)

The data processing device according to any one of (1) to (4) described above, in which
the security processing unit performs the security processing for each of high-gain image data and low-gain image data output from the sensor chip.
   (10)

The data processing device according to any one of (1) to (4) described above, in which
the security processing unit performs the security processing for each of image data of a long exposure time and image data of a short exposure time output from the sensor chip.
   (11)

The data processing device according to any one of (1) to (10) described above, further including:
a designation unit configured to designate data for each of the group for which the security processing is performed by the security processing unit.
   (12)

The data processing device according to (11), described above in which
the designation unit is able to switch setting designated data in one frame as the group and setting entire data of one frame as the group.
   (13)

An imaging system including:
an image sensor chip capable of acquiring image data or image plane phase difference data;
a security processing unit configured to perform security processing for each group including designated data among a plurality of types of data for one frame obtained from the image sensor chip; and
a transmission unit configured to frame data acquired by the security processing by the security processing unit and transmit the data to a host device, in which
the security processing unit performs the security processing for each of the group including the image data and the group including the image plane phase difference data.
   (14)

A distance measuring system including:
an iTOF sensor chip used to measure a distance to an object from a phase shift in reflected light of pulsed light output toward the object;
a security processing unit configured to perform security processing for each group including designated data among a plurality of types of data for one frame obtained from the iTOF sensor chip; and
a transmission unit configured to frame data acquired by the security processing by the security processing unit and transmit the data to a host device, in which
the security processing unit performs the security processing for each of the group including luminance data having a different phase output from the iTOF sensor chip.

Note that, the present embodiment is not limited to the embodiments described above, and various alterations can be made without departing from the gist of the present disclosure. Furthermore, the effects described herein are merely examples and are not limited, and other effects may be provided.

### REFERENCE SIGNS LIST

11 Imaging system
11A Distance measuring system
21 Imaging element
22 Host device
23 Focus drive unit
31 Image sensor chip
32 Signal processing chip
41 Image data processing unit
42 Image plane phase difference data processing unit
43 Security processing unit
44 Link layer interface
45 Physical layer interface
46 Processing range designation unit
47 Communication unit
51 Physical layer interface
52 Link layer interface
53 Memory
54 Output image processing unit
55 Autofocus processing unit
61 and 62 Security processing unit
71 iTOF device
72 iTOF sensor chip
81-1 to 81-4 Security processing unit
82 Depth map creation processing unit

1. A data processing device comprising:
a security processing unit configured to perform security processing for each group including designated data among a plurality of types of data for one frame obtained from a sensor chip; and
a transmission unit configured to frame data acquired by the security processing by the security processing unit and transmit the data to a host device.

2. The data processing device according to claim 1, wherein
the group is set according to a unit of data read from a memory that temporarily stores the data transmitted from the transmission unit in the host device.

3. The data processing device according to claim 1, wherein
the security processing unit performs processing of obtaining security information including at least one of a cyclic redundancy check (CRC) or a message authentication code (MAC) from the data of each group and adding the security information.

4. The data processing device according to claim 1, wherein
the security processing unit performs processing of encrypting the data of each group.

5. The data processing device according to claim 1, wherein
the sensor chip is an image sensor chip capable of acquiring image data or image plane phase difference data, and
the security processing unit performs the security processing for each of the group including the image data and the group including the image plane phase difference data.

6. The data processing device according to claim 5, wherein
processing of reading the image data from the memory that temporarily stores the data transmitted from the transmission unit and generating an output image is performed, and the image plane phase difference data is read and autofocus processing is performed, in the host device.

7. The data processing device according to claim 1, wherein
the sensor chip is an iTOF sensor chip used to measure a distance to an object from a phase shift in reflected light of pulsed light output toward the object, and
the security processing unit performs the security processing for each of the group including luminance data having a different phase, the luminance data being output from the iTOF sensor chip.

8. The data processing device according to claim 7, wherein
the luminance data of each phase is read line by line from the memory that temporarily stores the data transmitted from the transmission unit and a depth map is generated in the host device.

9. The data processing device according to claim 1, wherein
the security processing unit performs the security processing for each of high-gain image data and low-gain image data output from the sensor chip.

10. The data processing device according to claim 1, wherein
the security processing unit performs the security processing for each of image data of a long exposure time and image data of a short exposure time output from the sensor chip.

11. The data processing device according to claim 1, further comprising:
a designation unit configured to designate data for each of the group for which the security processing is performed by the security processing unit.

12. The data processing device according to claim 11, wherein
the designation unit is able to switch setting designated data in one frame as the group and setting entire data of one frame as the group.

13. An imaging system comprising:
an image sensor chip capable of acquiring image data or image plane phase difference data;
a security processing unit configured to perform security processing for each group including designated data among a plurality of types of data for one frame obtained from the image sensor chip; and
a transmission unit configured to frame data acquired by the security processing by the security processing unit and transmit the data to a host device, wherein
the security processing unit performs the security processing for each of the group including the image data and the group including the image plane phase difference data.

14. A distance measuring system comprising:
an iTOF sensor chip used to measure a distance to an object from a phase shift in reflected light of pulsed light output toward the object;
a security processing unit configured to perform security processing for each group including designated data among a plurality of types of data for one frame obtained from the iTOF sensor chip; and
a transmission unit configured to frame data acquired by the security processing by the security processing unit and transmit the data to a host device, wherein
the security processing unit performs the security processing for each of the group including luminance data having a different phase output from the iTOF sensor chip.
